(19) United States
(12) Patent Application Publication
(10) Pub. No.: US 2009/0315323 A1
(43) Pub. Date: Dec. 24, 2009

(54) GLASS-LIKE CARBON DEFORMED MOLDED ARTICLE, PROCESS FOR PRODUCING THE SAME, AND JOINT STRUCTURE FOR JOINTING A CONNECTING MEMBER TO A GLASS-LIKE CARBON HOLLOW MOLDED ARTICLE

(75) Inventors: Maki Hamaguchi, Kobe-shi (JP); Takayasu Fujiura, Kobe-shi (JP); Keiji Kishimoto, Kobe-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Kobe Seiko Sho (Kobe Steel Ltd.), Hyogo (JP)

(21) Appl. No.: 12/119,965

(22) Filed: May 13, 2008

Related U.S. Application Data
(62) Division of application No. 11/738,907, filed on Apr. 23, 2007, now abandoned.
Application No. 11/738,907 is a division of application No. 11/077,254, filed on Mar. 11, 2005, now abandoned.

(30) Foreign Application Priority Data
Mar. 24, 2004 (JP) 2004-087196
Aug. 3, 2004 (JP) 2004-226967
Aug. 31, 2004 (JP) 2004-252801

(51) Int. Cl. F16L 55/00

(52) U.S. Cl. 285/80

(57) ABSTRACT

Provided is a process for producing a glass-like carbon deformed molded article having a deformed section (typically, an elliptical section or a section composed of partial circles and linear portions), such as a glass-like carbon member in a deformed pipe form or a bent pipe, with relative ease and a good dimensional accuracy. The process comprises the step of molding a thermosetting resin to yield a thermosetting resin molded article, the step of deforming the thermosetting resin molded article plastically in the state that the article is heated, so as to yield a thermosetting resin deformed article, and the step of carbonizing the resultant thermosetting resin deformed article.

### CROSS-REFERENCE TO RELATED APPLICATIONS

This application is a divisional of and is based upon and claims the benefit of priority under 35 U.S.C. §120 for U.S. Ser. No. 11/077,254, filed Mar. 11, 2005, the entire contents of which are incorporated herein by reference. This application also claims the benefit of priority under 35 U.S.C. § 119 from Japanese Patent Application Nos. 2004-087196, filed Mar. 24, 2004, 2004-226967, filed Aug. 3, 2004, and 2004-252801, filed Aug. 31, 2004.

### BACKGROUND OF THE INVENTION

1. Technical Field

The present invention relates to a glass-like carbon deformed molded article suitable as a material for parts used in a high-temperature or corrosive environment, a production for producing the same, and a joint structure for jointing a connecting member to a glass-like carbon hollow molded article.

2. Related Art

Glass-like carbon exhibits a heat resisting temperature of 2000° C. or higher in an inert atmosphere, and also has excellent corrosion resistance against hydrogen fluoride and fluorine. Accordingly, glass-like carbon is expected to be applied to the following: parts of apparatus wherein corrosive gas is handled and impurities are required to be less generated, such as constituting parts of a semiconductor producing apparatus, in particular, those of a CVD machine (for example, a chamber in a Si wafer annealing device or a gas injection nozzle for injecting a reactant gas which is a material for forming a film onto a wafer); various other reaction vessels; and pipes for pipe arrangement for supplying/discharging gas or liquid into/from reaction vessels.

The glass-like carbon is generally produced by carbonizing a molded article made of a thermosetting resin, such as furan resin or phenol resin, at a high temperature.

Glass-like carbon itself cannot be subjected to welding joint or gluing joint; therefore, at time of producing a glass-like carbon member, it is common to mold a thermosetting resin, such as furan resin or phenol resin, into a form similar to that of a final product (i.e., to mold a resin into a pipe-like form when a final product is a pipe), and then heat-treat this thermosetting resin molded article in an inert atmosphere at a high temperature (usually, at 1000° C. or higher), so as to be carbonized.

However, glass-like carbon has problems about production technique thereof that the thermosetting resin which is raw material thereof has a low moldability and the resin is shrunken by about 20% in the carbonization. Thus, it is not easy to fabricate glass-like carbon member having a complicated shape with a high precision.

For example, about a glass-like carbon hollow molded article the section of which is simply circular (i.e., a glass-like carbon cylindrical product), the product can be produced by a usual method, such as centrifugal molding, using a thermosetting resin. However, in order to mold glass-like carbon into various members of a semiconductor film-forming apparatus or the like, it is necessary to use a deformed molded article the section of which is not circular. It is however impossible in principle to produce such a deformed molded article by centrifugal molding.

Examples of the glass-like carbon deformed molded article which is the subject or target of the present invention include a pipe 9 having a section (perpendicular to the axial direction of the pipe) in a rectangular form having four curved corners, and a pipe in a squashed hole form (or running track form), wherein two sides are in parallel, as illustrated in FIGS. 5A and 5B; pipes having an elliptical section; and pipes having a bent portion, as illustrated in FIG. 6.

When a glass-like carbon member in a cylindrical form or a deformed pipe form is produced, a core is usually used in order to ensure the dimensional accuracy of the product. The core is a member for keeping the shape of the product. At least one of the dimensions of the core is designed so as to be substantially equal to one dimension of the product after being carbonized, that is, after being shrunken. The core is used in the state that it is inserted into the thermosetting resin molded article before the carbonization, and has a function of controlling the shape and dimensions of the product into a given scope and range by supporting the product from the inside thereof (see Japanese Patent Application Laid-Open (JP-A-) No. 2002-179463).

At the time of producing, for example, a cylindrical glass-like carbon product, the following is inserted as a core into a thermosetting resin cylinder: a graphite cylinder having a smaller outside diameter than the resin cylinder and an outside diameter substantially equal to the inside diameter of the glass-like carbon cylinder after carbonization. In this state, the resin is carbonized.

JP-A No. 2000-313666 suggests a process for producing a glass-like carbon cylinder by forming thermosetting resin molded parts in a divided cylinder form, jointing the articles to each other to form a cylindrical molded article, and then carbonizing the article. However, this document does not disclose the production of a deformed pipe, such as a pipe which has an elliptical section or has a section composed of partial circle portions and linear portions. It is essentially difficult to form parts of a deformed pipe with a high dimensional accuracy and further position these parts accurately so as to be jointed with each other by the production process suggested in the document.

In order to produce a glass-like carbon bent pipe having a bent portion, a process wherein the production starts from a thermosetting resin bent pipe having a bent portion has been hitherto adopted as disclosed in JP-A No. 11-322428. However, the process has drawbacks that a large complicated metal mold is required to be used and the steps of molding the resin are complicated. It is essentially difficult to form parts of the pipe with a high dimensional accuracy and further position these parts accurately so as to be jointed with each other.

When a glass-like carbon deformed molded article is used as a chamber or a pipe for pipe arrangement which is connected to a reaction vessel, it is preferred to make the number of jointed portions therein as small as possible. This is because joint lines frequently cause dimensional strain, residual stress, and the generation of dust.

Regarding dimensional accuracy, the same problem applies to the case where cores are used. A drawback of the method using a core is that dimension-correcting effect of the core is insufficient since the gap between the core and a thermosetting resin molded article, which is a product, is large at the time of starting the carbonization of the article. In other words, the time when the core and the product contacts each other is a time when the carbonizing treatment is substantially finished; therefore, when the product deforms largely until this time, it is difficult to correct the dimensions thereof sufficiently even with the core. The difficulty becomes remarkable when the product is a deformed pipe.

Incidentally, in the case that a glass-like carbon pipe as described above is fitted to a container or the like when the pipe is used, an opening (supplying mouth) in the container or an opening in the glass-like carbon pipe (i.e., a pipe end opening) generally needs to have a sealing structure in order for fluid therein not to leak. Specifically, the structure is a cover which can be taken off or a nozzle-fitted flange for sealing the opening end of the hollow in the glass-like carbon pipe, or a connecting member (or connecting flange) used when another member is connected to the pipe.

It is possible to produce a hollow glass-like carbon hollow molded article wherein a cover or flange is directly connected to its opening. However, in the case of the cover, it may become necessary to take off the cover or set a nozzle to the cover in accordance with the intended purpose of the article. In order to apply the molded article to the purpose, it is preferred to develop a glass-like carbon hollow molded article having a removable cover, which may be a cover to which a nozzle or the like is beforehand fitted.

Since glass-like carbon is a brittle material, the tensile strength or bending strength thereof is poorer than that of ceramic materials used in this field, such as alumina or silicon carbide. Consequently, there is a substantial problem that according to a method for sealing a flange portion which is a method used in ordinary pipes and is an O-ring method as illustrated in FIG. 9, a large stress is generated by fastening-force as shown in arrows 33 for fastening a cover 31, which is made of glass-like carbon, stainless steel, quartz or the like, and a flange portion 32, so that the flange portion 32, which is made of the glass-like carbon, may be broken. When the cover and the flange portion are fastened by weak force, it is feared that a problem that sufficient sealing cannot be attained is caused. In FIG. 9, reference numbers 34 and 35 represent a hollow pipe-form molded article and an O-ring, respectively.

Thus, it is assumed that simply increasing the thickness of a glass-like carbon hollow molded article may lead to improvement of the strength thereof. However, in the case of glass-like carbon, the upper limit of the thickness which can be attained by the usual production method is about 3 to 4 mm. This thickness is insufficient for improving the strength. The reason why the thickness is limited is as follows: in the step of carbonizing a resin as starting material (i.e., a thermosetting resin such as phenol resin), a large amount of gas is generated; therefore, the resin is cracked or split when the thickness is too large.

For the connection of an end of an ordinary pipe member, there is known, for example, a joint structure as suggested in JP-A No. 2004-19832. When this structure is applied to the above-mentioned glass-like carbon hollow molded article, it is necessary to apply a large tensile stress to the flange of the glass-like carbon hollow molded article, as described about the case illustrated in FIG. 9, in order to cause a large fastening force to act on an O-ring between the flange of the pipe and an intermediate flange. As a result, there is a great possibility that the molded article (i.e., the pipe) may be broken. Conversely, when the above-mentioned flanges are loosely fastened so as not to break the glass-like carbon hollow molded article, leakage may not be prevented. When the section perpendicular to the hollow direction (i.e., the pipe-axial direction) of the glass-like carbon hollow molded article is not circular (but flat-circular or elliptical), the parallel portions of the flat circle or large arc portions of the ellipse become partially small in rigidity. Consequently, force for the sealing gives distortion to the parallel portions of the flat circle of the glass-like carbon hollow molded article or to the large arc portions of the ellipse of the article. Thus, the sealing may become incomplete.

### SUMMARY OF THE INVENTION

In light of the above-mentioned situation, the present invention has been made. An object thereof is to provide a process for producing a glass-like carbon deformed molded article, which has a deformed cross section (typically, an elliptical section or a section composed of partial circles and linear portions), such as a glass-like carbon member in a deformed pipe form or a bend pipe, with relative ease and a good dimensional accuracy; and a glass-like carbon deformed molded article. Another object is to provide a joint structure for jointing connecting member, such as a flange used for the connection of another member or a cover, to an opening end of a glass-like carbon hollow molded article, such as a glass-like carbon hollow molded article of insufficient thickness in strength or of noncircular in shape of cross section, in such a manner that the connecting member can be taken off and yet the joint structure can be sealed well.

In order to attain the above-mentioned objects, the process according to one aspect of the present invention for producing a glass-like carbon deformed molded article, comprises:

the step of molding a thermosetting resin to yield a thermosetting resin molded article,

the step of deforming the thermosetting resin molded article plastically in the state that the article is heated, so as to yield a thermosetting resin deformed article, and

the step of carbonizing the resultant thermosetting resin deformed article.

Assuming that the thermosetting resin molded article is a cylindrical molded article and the thermosetting resin deformed article is a thermosetting resin deformed pipe, a glass-like carbon deformed pipe can be yielded.

Assuming that the thermosetting resin molded article is a thermosetting resin pipe in a straight form, and that the plastically-deforming step is a step of applying bending force to a region of the thermosetting resin pipe which is to be bent in the state that the region is heated so as to deform the region plastically to form a bent portion, a glass-like carbon bent pipe can be yielded.

In the process according to the aspect of the present invention for producing a glass-like carbon deformed molded article, it is preferred that the plastically-deforming step is performed at a temperature T (° C.) satisfying the following expression (1):

(Tg+5° C.)≦T≦(Tg+150° C.) (1)

wherein Tg represents the glass transition point of the thermosetting resin molded article, and

it is also preferred that the glass transition point Tg of the thermosetting resin molded article is from 25 to 100° C. (inclusive).

The process according to the aspect of the present invention for producing a glass-like carbon deformed molded article may further comprise the step of fitting a flange or flanges to one end face or both end faces of the plastically-deformed thermosetting resin deformed pipe.

In the case that a glass-like carbon deformed pipe is yielded by the process of the aspect of the present invention, it is preferred that a core having substantially the same carbonization shrinkage ratio as the thermosetting resin deformed pipe is arranged in the hollow of the thermosetting resin deformed pipe in the carbonizing step, so as to carbonize the resin deformed pipe and further it is preferred that the core is made of the same thermosetting resin as constitutes the thermosetting resin deformed pipe.

The glass-like carbon deformed pipe according to the aspect of the present invention is a pipe having no joint portion in the direction parallel to the longitudinal direction of the pipe. The glass-like carbon bent pipe according to the aspect of the present invention has a bent portion without having any joint.

The joint structure according to the aspect of the present invention is a joint structure for jointing a connecting member to an opening end of a glass-like carbon hollow deformed pipe, which comprises the connecting member, the member being a member wherein a flange portion is formed to be integrated with an outer periphery of a sleeve portion which can be inserted into the glass-like carbon deformed pipe, a sealing material arranged on an outer periphery of the opening end of the glass-like carbon deformed pipe, and a holding member for sandwiching this sealing material between the holding member itself and the flange portion of the connecting member to hold the sealing material, wherein the holding member is fastened and fitted onto the flange portion through a fastening means so as to compress the sealing material held between the holding member and the flange portion, thereby jointing the connecting member to the opening end of the glass-like carbon deformed pipe.

In the joint structure, it is preferred that an elastic member is arranged on at least one portion of the outer peripheral surface of the sleeve portion inserted into the glass-like carbon pipe, and it is also preferred that the connecting member and the holding member are each made of a metal or a ceramic.

The joint structure according to the aspect of the present invention for jointing a connecting member to a glass-like carbon deformed pipe is applied to a glass-like carbon hollow molded article.

According to the process according to the invention for producing a glass-like carbon deformed molded article, it is possible to use a cylindrical molded article made of a thermosetting resin to produce a glass-like carbon member in a deformed pipe form or a bent pipe, which has a deformed section, typically, an elliptical section or a section composed of partial circles and linear portions, with relative ease and a good dimensional accuracy. By using, as the thermosetting resin cylindrical molded article, an article having no joint line in the axial direction of the cylindrical molded article, a glass-like carbon deformed pipe or bent pipe good in corrosion resistance and strength can be produced. Such a glass-like carbon deformed pipe or bent pipe having no joint portion is better in corrosion resistance and strength than a pipe having a joint portion, and is easily applied to a chamber of a semiconductor producing apparatus, wherein its glass-like carbon pipe is exposed to corrosive environment, or the like.

According to the joint structure of the invention for jointing a connecting member to a glass-like carbon hollow molded article, a connecting member used for the connection of a different member, such as a flange, or a cover as a connecting member can be fitted to an opening end of a glass-like carbon hollow molded article having a small thickness to exhibit an insufficient strength or having a non-circular section in such a manner that the connecting member can be taken off and the joint structure can well be sealed. The sealing of the joint portion can be ensured by means of the sealing material (such as an O-ring) arranged on the outer periphery of the opening end of the glass-like carbon hollow member; therefore, even if the length or the thickness of the glass-like carbon hollow molded article is expanded under the use conditions thereof, the air-tightness can be maintained.

### BRIEF DESCRIPTION OF THE DRAWINGS

FIGS. 1A and 1B are explanatory views illustrating an embodiment of the plastically-deforming step of yielding a thermosetting resin deformed pipe from a thermosetting resin cylindrical molded article according to the present invention, and FIG. 1A and FIG. 1B illustrate a state of the molded article before plastic deformation and that after the plastic deformation, respectively.

FIG. 2 is a perspective view of the thermosetting resin deformed pipe according to the present invention.

FIGS. 3A and 3B are perspective views illustrating an embodiment of the carbonizing step of yielding a glass-like carbon deformed pipe from the thermosetting resin deformed pipe according to the present invention, and FIG. 3A and FIG. 3B illustrate a state of the deformed pipe before carbonization treatment and that after the carbonization treatment, respectively.

FIGS. 4A and 4B are explanatory views illustrating an embodiment of the carbonizing step of yielding a glass-like carbon deformed pipe from a thermosetting resin deformed pipe of Comparative Example, and FIG. 4A and FIG. 4B illustrate a state of the deformed pipe before carbonization treatment and that after the carbonization treatment, respectively.

FIGS. 5A and 5B are each a sectional view illustrating an example of a sectional shape of a thermosetting resin deformed pipe according to the present invention, and FIGS. 5A and 5B illustrate a rectangle having four rounded corners and a flat-circular shape (track shape) having two parallel sides.

FIG. 6 is a sectional view illustrating an example of a sectional shape of a thermosetting resin bent pipe according to the present invention along the longitudinal direction of the pipe.

FIGS. 7A and 7B are explanatory views illustrating a joint structure according to the present invention for jointing a connecting member to a glass-like carbon hollow member, and FIGS. 7A and 7B are a front view thereof and an enlarged sectional view taken on line X-X of FIG. 7A, respectively.

FIGS. 8A and 8B are explanatory views of the connecting member illustrated in FIGS. 7A and 7B, and FIGS. 8A and 8B are a front view thereof and a top view thereof, respectively.

FIG. 9 is a sectional view illustrating a conventional joint structure for jointing a connecting member to a glass-like carbon hollow molded article.

FIGS. 10A, 10B, and 10C are sectional views for explaining the production process of the present invention, and FIG. 10A is a view illustrating a thermosetting resin straight pipe, FIG. 10B is a view illustrating a situation that sea sand is filled in this pipe, and FIG. 10C is a view illustrating a situation that a bent portion is formed by plastic deformation.

### BEST MODES FOR CARRYING OUT THE INVENTION

The present invention is specifically described hereinafter.

The process according to the present invention for producing a glass-like carbon deformed molded article comprises: the step of molding a thermosetting resin to yield a thermosetting resin cylindrical molded article, the step of deforming the thermosetting resin cylindrical molded article plastically in the state that the article is heated, so as to yield a thermosetting resin deformed article, and the step of carbonizing the resultant thermosetting resin deformed article.

In the above-mentioned step of yielding a thermosetting resin cylindrical molded article, a resin as raw material is molded into a cylindrical form. The method for the molding in this case is not particularly limited, and may be selected from known techniques such as centrifugal molding, injection molding and extrusion molding. Of these molding methods, centrifugal molding is particularly preferable for the following reasons: since the centrifugal molding causes a raw material resin in a melt state to flow toward the inner surface of a mold by centrifugal force and be then cured, the resin can easily be molded into a cylindrical article with a high dimensional accuracy; since the inner surface side of the article is opened at the time of the molding, gaseous substances formed by curing reaction can be satisfactorily removed; and no joint line is formed in a glass-like carbon deformed pipe or bent pipe, which is another advantage for the use manner of the pipe. The raw material resin may be a known thermosetting resin such as phenol resin or furan resin.

In the above-mentioned step of yielding a thermosetting deformed article, the thermosetting resin cylindrical molded article yielded in the above-mentioned step is plastically deformed in the state that the article is heated. The method for attaining the plastic deformation is not particularly limited.

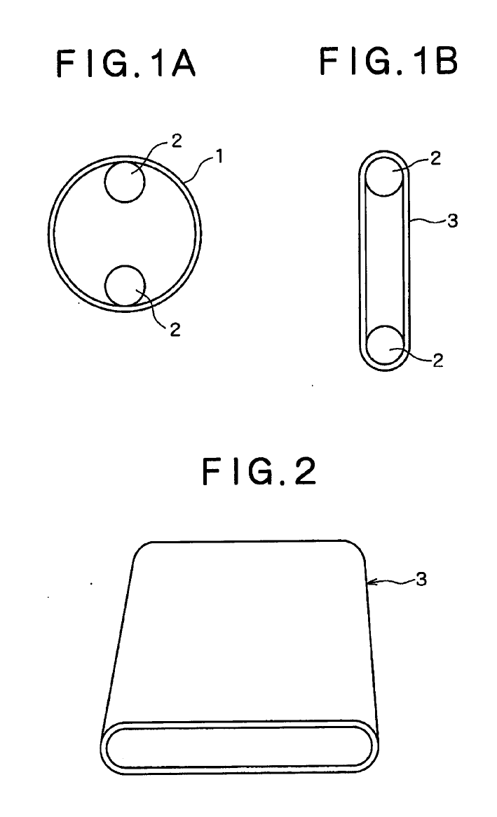

In the case of yielding, for example, a deformed pipe, the above-mentioned method may be a method of using split molds having the same shape as the deformed pipe to apply a load to the resin cylindrical molded article by pressing while heating the article, thereby fitting the article into the molds, or a method of setting at least two rodlike tools onto the inner peripheral surface of the thermosetting resin cylindrical molded article and then pushing/opening the rodlike members in the radial direction while heating the article. FIGS. 1A and 1B are explanatory views illustrating an embodiment of the latter plastic deformation method. In the plastic deformation illustrated in FIGS. 1A and 1B, two round-bar rods 2 are set onto the inner peripheral surface of a thermosetting resin cylindrical molded article 1 (see FIG. 1A). Next, the round-bar rods 2 are pushed/opened in the radial direction with a pushing/opening means (not illustrated) while the molded article 1 is heated to a given temperature (see FIG. 1B). A thermosetting resin deformed pipe 3 obtained by this working is shown in FIG. 2.

In the case of yielding a bent pipe, examples of the plastic deformation method include a method of heating at least one region to be bent of the thermosetting resin cylindrical molded article (pipe) and then using split molds having a bent portion to apply a load to the article by pressing so as to fit the article into the split molds; a method of heating at least one region to be bent of the thermosetting resin cylindrical molded article (pipe) and then pushing and bending a region to be bent of the thermosetting resin pipe; and a method of heating at least one region to be bent of the thermosetting resin cylindrical molded article (pipe) and then setting a tool to the resin pipe and then pushing/bending both sides of the pipe across the tool.

The above-mentioned plastic deformation is described in more detail hereinafter.

It is in general known that a thermosetting resin cylindrical molded article is not easily machine-worked since the article is poor in toughness. It is not therefore easy to produce a molded article (deformed pipe) having a complicated shape or a bent pipe by jointing thermosetting resin molded articles composed of beforehand-separated pieces. Thus, the inventors have made various investigations on the production of thermosetting resin deformed molded articles so as to find out that a thermosetting resin cylindrical molded article is plastically deformed with ease by applying force to the article while heating the article to the glass transition temperature (hereinafter denoted as Tg) thereof or higher. Thus, the present invention has been made.

In this case, it is preferred that the temperature T (° C.) of the thermosetting resin molded article is within the range of (Tg+5° C.) to 150° C. when the article is plastically deformed. If the temperature T is lower than this range, that is, if the temperature difference (T−Tg) is smaller than 5° C., a large force is necessary for the plastic deformation. Thus, the article is frequently broken. It is therefore preferred that the temperature T is a higher temperature than Tg by 5° C. or more. In the case of bending a straight pipe to yield a bent pipe, it is preferred that the temperature T is a higher temperature than Tg by 10° C. or more.

The upper limit of the temperature T is preferably 150 or lower in the light of the curing rate of the thermosetting resin. As the temperature T is higher, the deformability of the thermosetting resin is higher so that the operation for deforming the resin is more easily conducted. However, if the temperature is too high, the reaction for curing the resin advances rapidly. As a result, the time which can be used for the deformation operation becomes too short. The upper limit is preferably 120° C. or lower, more preferably 90° C. or lower.

It is preferred that the thermosetting resin cylindrical molded article supplied to plastic deformation has a Tg of 100° C. or lower, more preferably 60° C. or lower. If the Tg is high, it is necessary to heat the molded article to a higher temperature in order to deform the article plastically. For this reason, the deformation operation is difficult and further the curing reaction advances rapidly during the plastic deformation operation so that the article cannot be easily deformed. The lower limit of the Tg is not particularly limited. Regarding Tg, its lower limit is not defined, but generally the lower the better. If the Tg is too low, the stiffness of the article is insufficient even at room temperature so that the article cannot be easily handled. It is therefore preferred that the resin has a Tg of not lower than a temperature close to room temperature, or not lower than 25° C.

The following describes the plastically-deforming step in the case of yielding a glass-like carbon deformed pipe and the plastically-deforming step in the case of yielding a bent pipe, respectively.

### <Glass-Like Carbon Deformed Pipe>

As described above, the plastic deformation is performed by a method of using split molds having the same shape as a deformed pipe to be yielded to apply a load to the thermosetting resin cylindrical molded article by pressing while heating the article, thereby fitting the article into the molds, or a method of setting at least two rodlike tools onto the inner peripheral surface of the molded article and then pushing/opening the rodlike members in the radial direction while heating the article. Of course, however, there is a limit to the scope that the thermosetting resin cylindrical molded article can be plastically deformed. This limit is deformation limit. If the article is plastically deformed beyond the deformation limit, defects such as cracks or fracture are caused. The curvature radius of the cylindrical molded article before plastic deformation, that after the plastic deformation are represented by R and R′, respectively. The ratio therebetween (R′/R) and the ratio of the thickness of the cylindrical molded article to the radius R thereof before the plastic deformation (the thickness/R) are represented by t and w, respectively. It is assumed that the center of the cylindrical molded article in the thickness direction is neutral to the deformation (or is changeless in dimension) and the inside and the outside of the cylindrical molded article are evenly deformed, so that the change in the thickness can be ignored. In this case, the change rate lo of the circumferential length of the outer periphery and that li of the circumferential length of the inner periphery are represented by the following equations, respectively:

lo=(t+w/2)/[t(1+w/2)], and

li=(t−w/2)/[t(1−w/2)]

The change rates lo and li, which are varied by the nature of the resin, are each preferably 10% or less, more preferably 5% or less. For example, when one portion of a cylinder having a thickness of 3 mm and a thickness-center-diameter of 3 mm is plastically deformed into a deformed pipe having a circular arc having a thickness-center-diameter of 60 mm, the change rates in the outer periphery and the inner periphery are each about 4%. (The thickness-center-diameter referred to herein is the diameter of the circle which constitutes the central line in the thickness direction of the above-mentioned cylindrical molded article.)

As represented by the above-mentioned equations, the change rates of the outer periphery and the inner periphery are affected by the ratio of the thickness to R. Straightforwardly, as the thickness is larger, the change rates are larger. If the thickness is changed from 3 mm to 6 mm in the above-mentioned example, the change rate will be twice to obtain the same deformation ratio. In other words, the small thickness is preferable as long as the component designing operation is freed from any problem. In the case that a large plastic deformation exhibiting a change rate of 10% or more is caused, there is a great possibility that a defect is generated in the resin molded article. Thus, this case is not preferred. The velocity of the plastic deformation is not particularly limited. In general, a good result is given when the deformation is conducted in the state that a load is applied to the molded article over a time in the range of several minutes to several hours. A rapid deformation may promote deterioration of the resin.

### <Bent Pipe>

As described above, the formation of a bent portion of a pipe is attained by heating a region to be bent and then using split molds having a bent portion to apply a load to the pipe by pressing so as to fit the pipe into the split molds; pushing and bending a region to be bent of a straight thermosetting resin pipe; or setting a tool to a thermosetting resin pipe and then pushing/bending both sides of the pipe across the tool. About the heating of the thermosetting resin pipe at this time, it is preferred to heat only the region thereof to be bent for the following reason: if an excessively wide portion of the pipe is heated, an undesired portion is deformed. Specifically, it is preferred to heat the area consisting of [the pipe area corresponding to the bent (elbow) portion obtained after the deformation] and [the pipe area from each end of the above-mentioned area to a position about 5 to 30 mm apart from the end].

When bending force is applied to a straight thermosetting resin pipe so as to bend the pipe, it is important to fill powder into the pipe in order to prevent the bent hollow portion of the pipe from being deformed.

The effect of the filled powder is described hereinafter. When a thermosetting resin pipe wherein nothing is filled into its hollow portion is heated up to a temperature at which the pipe can be softened so as to be bent, tensile stress is generated in the outer peripheral side of the bent portion. Consequently, the pipe hollow portion is deformed so that the inside diameter thereof becomes small. When this phenomenon is remarkable, the resultant pipe does not function as a pipe arrangement member. On the other hand, when powder having an appropriate fluidity is filled into the hollow of the pipe to be bent, the powder follows bending deformation while the powder resists against force for deforming the pipe. Consequently, a bent portion can be formed without being substantially deformed. The wording “appropriate fluidity” means fluidity making it possible to cause the powder to flow into the pipe and flow out therefrom easily.

Examples of the powder suitable for this purpose include various sands, silica, carbon powders such as graphite, ceramic powders, glass powders, and plastic powders. Of these, sea sand can easily be obtained and used. Powders which are too fine and large in compactability, such as wheat, and powders which can easily be crushed, such as styrene foam powder, are not preferred. The grain size of the powder is suitably from about 0.1 to 1 mm.

The portion into which the powder should be filled may be in principle only the portion to be plastically deformed. It is simple and highly practicable to fill the powder into the whole of the pipe. The filling fraction may be such a filling fraction that the powder is filled into the pipe by gravity effect. If the filling fraction is lower than such a filling fraction, the effect of the filling is small. If the filling fraction is higher than it, the powder may not follow the deformation of the pipe. The filling fraction is actually from about 70 to 90%.

The shape and size of the bent portion of the thermosetting resin bent pipe should be appropriately set in accordance with the specification of a member to be obtained. The present invention is applied preferably to pipes having a ratio of the thickness to the pipe outside diameter of 1/20 or more, more preferably 1/10 or more. If this ratio is small, the rigidity of the whole of the pipe is small. Consequently, the pipe may be broken when the pipe is plastically deformed.

It is preferred to set the inside curvature radius of the bent portion of the thermosetting resin bent pipe to be equal to the outside diameter of the pipe or more for the following reason: if the inside curvature radius is too small, the deformation ratio of the outer periphery and that of the inner periphery of the bent portion become too large so that the pipe may be broken. When the inside curvature radius is equal to the outside diameter of the pipe, the deformation ratio of the outer periphery and that of the inner periphery are each about 25%. Thus, the pipe can be bent without being broken by setting conditions for heating the pipe appropriately. No upper limit is given to the inside curvature radius. The velocity of the plastic deformation is not particularly limited. In general, good results can be obtained when the pipe is deformed with the application of a load for several minutes to several hours. A rapid deformation may promote deterioration of the thermosetting resin.

The thermosetting resin pipe having the bent portion formed by the plastic deformation is rapidly cooled once to fix the structure thereof. Since the pipe is deformable in the state that the pipe has been just deformed under heating, undesired deformation is easily caused. The method for the rapid cooling is not particularly limited, and may be, for example, a method of immersing the pipe into cold water. The cooling is continued at least until the temperature of the pipe becomes a temperature lower than Tg. When an appropriate mold is used, the rapid cooling is unnecessary since there is a possibility that undesired deformation is caused.

After the pipe is plastically deformed as described above, the pipe is subjected to curing at a higher temperature (i.e., heating for promoting chemical reaction), thereby preventing the pipe from further undergoing undesired deformation so as to cure the pipe completely. Conditions for the curing are varied by the plastic deformation temperature. In the case of using, for example, phenol resin, the resin is cured in the air at a temperature of 180 to 350° C. for a time of 10 to 100 hours.

The following describes the step of carbonizing the thermosetting resin deformed molded article.

In this carbonizing step, the thermosetting resin deformed molded article obtained in the above-mentioned plastically-deforming step is subjected to carbonizing treatment to yield a glass-like carbon deformed molded article. The carbonizing treatment is generally carried out by heat-treating at a temperature of 800 to 2500° C. in an non-oxidizing atmosphere (inert gas atmosphere).

As described above, a glass-like carbon deformed molded article having a desired shape can be obtained. For example, a shrunken glass-like carbon deformed pipe having the same shape as the thermosetting resin deformed pipe 3 in FIG. 2 can be obtained.

Incidentally, when a glass-like carbon deformed pipe (product) is fabricated, it is preferred to use a core having substantially the same carbonization shrinkage ratio as a thermosetting resin deformed pipe which is a product precursor in order to achieve good dimensional accuracy of the product. In this case, dimensions of the core can be made substantially the same as at least one portion of the inside diameter (inside shape) of the product precursor. This is because the core undergoes carbonization shrinkage in the same manner as the product precursor. This core has an effect of keeping the shape of the product from the inside thereof from the start of the carbonization treatment to the end thereof.

The wording “substantially the same carbonization shrinkage ratio” means that the difference between the product dimension shrinkage ratio and the core dimension shrinkage ratio based on the carbonization treatment is within ±2%, preferably ±1%. In the case of carbonizing a thermosetting resin molded article of, e.g., 100 mm size, the article shrinks on carbonization to about 80% of the original length, which is somewhat varied by the kind of the resin, and, a shrinkage ratio difference of 2% corresponds to a dimensional difference of 2 mm in the final products. An object giving a smaller difference than this difference functions as the core. An object giving a larger difference than this difference does not have a sufficient function for keeping the shape of the product, or may cause the product (glass-like carbon deformed pipe) to be broken.

The material of the core and that of the product may be made substantially the same, so as to make the carbonization shrinkage ratio of the core equal to that of the product. The core may be made from a combination of two or more materials, such as graphite and a thermosetting resin, so as to cause the shrinkage ratio of the whole of the core to be matched with that of the product. In these manners, the same effect can be obtained.

The wording “substantially the same materials” means resin materials of the same type. In the case that the glass-like carbon deformed pipe is made of, for example, phenol resin, the core may be made of inexpensive foamed phenol resin having substantially the same carbonization shrinkage ratio.

The core may have the same shape as the hollow portion of the thermosetting resin deformed pipe, that is, may be a substantially rectangular parallelepiped which has a section in the form of a track or a rectangle having 4 rounded corners and which extends in the longitudinal direction of the deformed pipe. The core is preferably composed of plural rectangular parallelepiped pieces which: each have an arbitrary width and a height equal to the distance between parallel planes of the thermosetting resin deformed pipe; each extend in the longitudinal direction of the deformed pipe; and are arranged at arbitrary intervals in the section longitudinal direction between the parallel planes of the deformed pipe. This is because a large amount of the resin is unnecessary for the core and the core can easily be taken off after the carbonization.

It is effective to sandwich a flexible material such as a graphite felt or a ceramic sheet between the core and the product in order to prevent excessive contact between the core and the product and breakdown of the core.

One or more flanges may be fitted to one end or both ends of the above-mentioned glass-like carbon deformed pipe. The following describes the step of forming the flanges. For the molding of any one of the flanges, known methods, for example, the following three methods can be used.

### (1) Press Molding or Injection Molding

A mold having a flange shape is used to mold a thermosetting resin, such as phenol resin, under high pressure, thereby forming a flange part. This part is bonded to one of the ends of the plastically-deformed thermosetting resin deformed pipe.

### (2) Cast Molding

A liquid thermosetting resin is cast into a mold having a cavity for a flange structure. The resin is thermoset to form a flange part. The flange part is bonded to one of the ends of the plastically-deformed thermosetting resin deformed pipe. Alternatively, the thermosetting resin deformed pipe is inserted into the same mold as described above, and then a liquid thermosetting resin is cast thereinto and thermoset, thereby integrating a flange portion with one of the ends of the thermosetting resin deformed pipe.

The above-mentioned bonding between the flange part and the thermosetting resin deformed pipe can be performed by a known method, such as a method of using a liquid thermosetting resin as an adhesive agent, or a method of filling a powdery resin into a joint portion and then heating the resin under the application of a load so as to melt the resin. In the two methods, different thermosetting resins may be used as materials of the flange part, the thermosetting resin deformed pipe and the adhesive agent. Desirably, the same material should be used to make the carbonization shrinkage ratios of these members as near to each other as possible. This makes it possible to prevent an uneven dimension-change (a accuracy-drop) at the time of the carbonization treatment.

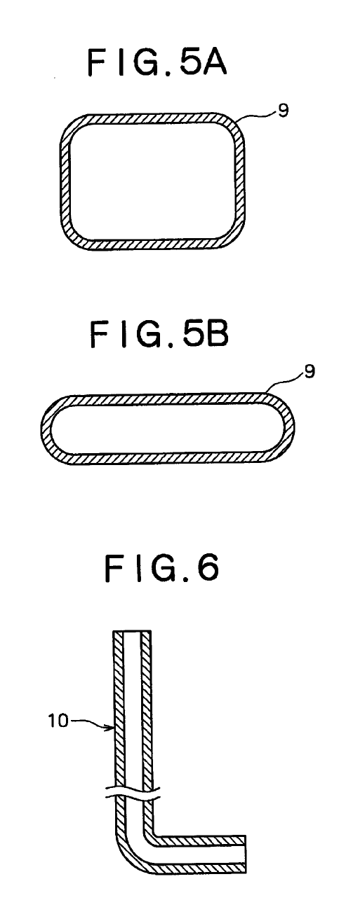

When the glass-like carbon pipe is used as a chamber of a semiconductor producing apparatus, a pipe of a reaction vessel or the like, the glass-like carbon pipe is exposed to a corrosive environment. Therefore, in the case that a joint portion is present therein, corrosion or strength of the joint portion becomes a problem. In particular, in the case of a glass-like carbon deformed pipe or a bent pipe, it is difficult to produce the pipe without having any joint portion, which is different from the case of a pipe having a circular section or a straight pipe. However, the glass-like carbon deformed molded article produced by the above-mentioned production process of the present invention has, in its bent portion, no joint, or has no joint line in the direction parallel to the longitudinal direction of the pipe. Therefore, the deformed molded article is good in corrosion resistance and strength. About the glass-like carbon deformed molded article produced by the present invention, its section can be made into an arbitrary shape, such as a track shape, or a shape composed of linear portions and partial circles, for example, a rectangle having 4 rounded corners (see FIG. 5). Furthermore, a deformed pipe having one end or both ends to which a flange or flanges is/are fitted can easily be produced.

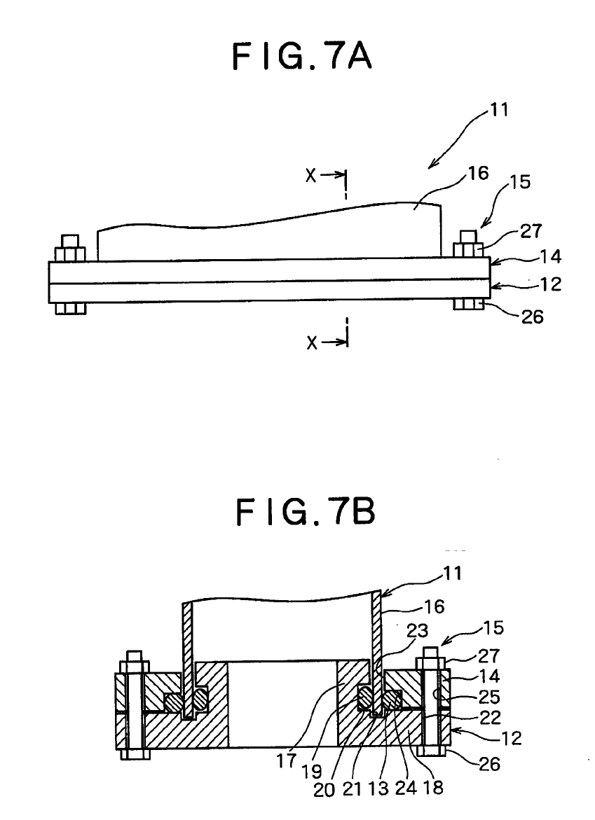

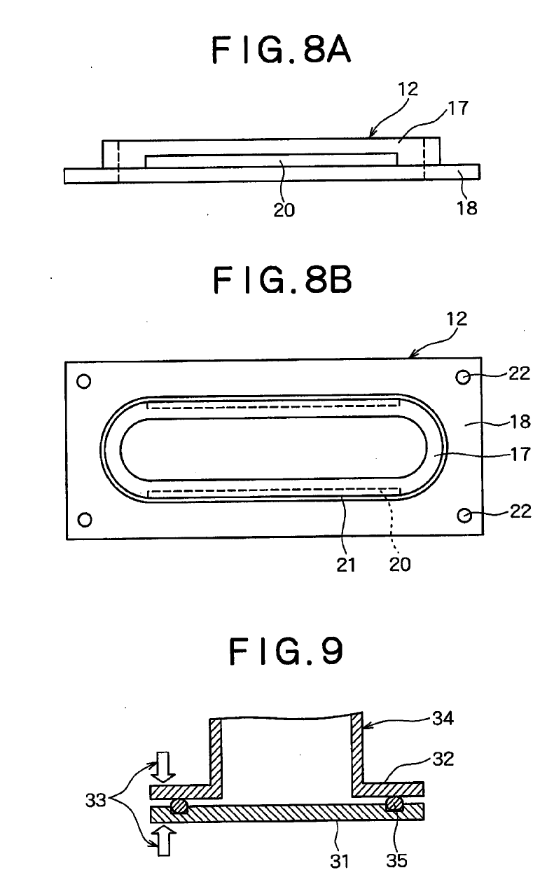

The following describes a joint structure of the present invention for jointing a connecting member to a glass-like carbon hollow molded article with reference to the attached drawings. FIGS. 7A and 7B are explanatory views illustrating a joint structure according to the invention for jointing a connecting member to a glass-like carbon hollow molded article. FIG. 7A is a front view thereof and FIG. 7B is an enlarged sectional view taken on line XX of FIG. 7A. FIGS. 8A and 8B are explanatory views of the connecting member illustrated in FIG. 7. FIG. 8A is a front view thereof, and FIG. 8B is a top view thereof.

In FIG. 7, reference number 11 represents the glass-like carbon hollow molded article; 12, the connecting member; 13, a sealing material; 14, a holding member; and 15, a fastening means. The glass-like carbon hollow molded article 11 is a glass-like carbon deformed pipe having a flat-circular section in this example.

The connecting member 12 has a sleeve portion 17 which can be inserted into a pipe end (opening end) 16 of the glass-like carbon hollow molded article 11, and a flange portion 18 formed to be integrated with the outer periphery of an end of the sleeve portion 17. A groove 20, into which an elastic member 19 is fitted, is made in the sleeve portion 17 near the cross portion of the outer peripheral surface of the sleeve portion 17 and the flange portion 18. In the present example, the groove 20 is made in the portion corresponding to parallel planes of the glass-like carbon hollow molded article 11. A groove 21, into which a pipe end of the glass-like carbon hollow molded article 11 can be inserted, is made in the flange portion 18. Bolt holes 22 are made in four corners of the flange portion 18. The material of the connecting member 12 is selected from glass-like carbon, stainless steel, quartz and others in accordance with the purpose of the member 12. The present example is an example wherein the elastic member 19 is fitted, and a case where the joint structure has the fitting groove 20 therefor is described. However, a sleeve 17 having no elastic member 19 or the fitting groove 20 so as to have a flat outer peripheral surface may be used.

In the present example, an O-ring having a large deforming margin is used as the sealing material 13. According to this sealing member, the seal surface of the O-ring is slid but the sealability of the joint can be ensured even if the length of the glass-like carbon hollow molded article 11 is varied.

The holding member 14 is a flat plate having the same external form as the flange portion 18, and has a through hole 23, through which the glass-like carbon hollow molded article 11 can be inserted. A notch groove 24, which makes it possible to push and press the sealing material (O-ring) 13 between the holding member 14 and the flange portion 18, is made around the through hole 23 near the flange portion 18. Bolt holes 25 are made in four corners of the holding member 14, correspondingly to the bolt holes 22 made in the four corners of the flange portion 18. The bolt holes 22 or 25 are made in the 4 corners. Needless to say, however, the position and the number of the holes may be appropriately set in accordance with the size of the sectional shape of the glass-like carbon hollow molded article 11, considering the sealability.

In the present example, the fastening means 15 is composed of bolts 26 and nuts 27, and is fitted to the joint structure by fastening the nuts 27 onto the bolts 26.

The jointing of the connecting member 12 to the glass-like carbon hollow molded article 11 by use of the above-mentioned constituting members is attained as follows. First, the holding member 14 and the O-ring 13 are fitted to the outer periphery of a pipe end of the glass-like carbon hollow molded article 11, and the elastic member (for example, a string-form member made of the same as the material of the O-ring) 19 is fitted into the fitting groove 20 in the sleeve portion 17 of the connecting member 12. Next, the sleeve portion 17 of the connecting member 12, together with the elastic member 19 fitted into the fitting groove 20, is inserted into a pipe end of the glass-like carbon hollow molded article 11, and is further inserted thereinto until the pipe end of the article 11 is fitted to the inside of the groove 21 in the flange portion 18 of the connecting member 12. Thereafter, while the above-mentioned state is kept, the bolts 26 of the fastening means 15 are inserted into the bolt holes 22 in the connecting member 12 and the bolt holes 24 in the holding member 24. The nuts 27 are then fastened onto the bolts. In this way, the O-ring 13 inside the notch groove 24 in the holding member 14 is compressed between the flange 18 and the holding member 14, so as to push and press the pipe end of the article 11, thereby jointing the connecting member 12 to the article 11.

Since the connecting member 12 is jointed to the pipe end of the glass-like carbon hollow molded article 11 as described above, the sealability of the joint portion is ensured with the O-ring 13. The O-ring 13 preferably has a large deforming margin. In the case that the glass-like carbon hollow molded article 11 expands or shrinks by temperature change, the seal surface of the O-ring 13 is slid. However, when the O-ring having a large deforming margin is used and the O-ring is largely deformed to seal the joint portion, the sealability thereof can be ensured even if the article 11 expands or shrinks. When the bolts 25 of the fastening means 15 are loosened, the jointing can be cancelled. Thus, the connecting member 12 can easily be taken off from the pipe end of the article 11.

The above-mentioned embodiment is an example using bolts 26 and the nuts 27 as the fastening means 15. It is however allowable to put the flange portion 18 of the connecting member 12 on the holding member 14, fitting a U-shaped clasp onto the outer periphery of these members in this state, and then fastening the U-shaped clasp with bolts or wedges.

### EXAMPLES

### Production of a Glass-Like Carbon Deformed Pipe

### Example 1

A commercially available liquid phenol resin (Resitop PL-4804, manufactured by Gunei Chemical Industry Co., Ltd.) was subjected to heat treatment at 100° C. under a reduced pressure for 1 hour to adjust the water content therein. The resultant was used as a raw material of glass-like carbon. A centrifugal molding die having an inside diameter of 325 mm and a length of 1600 mm was used to mold this raw material by centrifugal molding, thereby yielding a phenol resin cylinder of 320 mm diameter and 3.5 mm thickness. The glass transition point thereof was 65° C.

The resultant cylinder was cut into a length of 600 mm. As illustrated in FIG. 1, two stainless steel pipes (rodlike tools) of 60 mm outside diameter and 600 mm length were inserted into the cut cylinder. One thereof was put so as to hold the cylinder and the other was put as a load on the bottom of the cylinder (see FIG. 1A). In this state, the cylinder was heated at 90° C. for 5 hours to yield a phenol resin deformed cylinder having a section in a track form (see FIG. 1B). Thereafter, the phenol resin deformed cylinder was carbonized in a usual way, so as to yield a glass-like carbon deformed pipe, 480 mm in total length, having no joint line in the longitudinal direction and having a section composed of semicircular portions of 48 mm diameter and parallel portions of 340 mm length.

### Example 2

### Example Wherein a Flange was Jointed to an End of a Pipe

A phenol resin deformed cylinder having a section in a track form was yielded by the same production process as in Example 1. Separately, the same raw material as used in Example 1 was used and molded into a phenol resin pipe of 3 mm thickness by centrifugal molding. The molded pipe was cut open to yield a phenol resin plate of 3 mm thickness. From this plate, a resin plate in a track and doughnut form was cut out, which had a width of 86 mm, a parallel portion length of 425 mm and a circular portion radius of 33 mm, and had, at the center thereof, a hole having a shape equal to the external shape of the above-mentioned track-form phenol resin deformed cylinder. The two members were jointed to each other with a phenol resin, and the resultant was carbonized in the same usual way as in Example 1, so as to yield a glass-like carbon deformed pipe, 480 mm in total length, having a section composed of circular portions of 48 mm diameter and parallel portions of 340 mm length and having in one end thereof a flange of 8 mm width.

### Example 3

### Example Wherein a Core was Used

A commercially available liquid phenol resin (Resitop PL-4804, manufactured by Gunei Chemical Industry Co., Ltd.) was subjected to heat treatment at 100° C. under a reduced pressure for 1 hour to adjust the water content therein. The resultant was used as a raw material of glass-like carbon. A centrifugal molding die having an inside diameter of 325 mm and a length of 1600 mm was used to mold this raw material by centrifugal molding, thereby yielding a phenol resin cylinder of 320 mm diameter and 3.5 mm thickness.

The resultant cylinder was cut into a length of 500 mm. As illustrated in FIG. 1, two stainless steel pipes (rodlike tools) of 60 mm outside diameter and 600 mm length were inserted into the cut cylinder. One thereof was put so as to hold the cylinder and the other was put as a load on the bottom of the cylinder (see FIG. 1A). In this state, the cylinder was heated at 90° C. for 5 hours to yield a phenol resin deformed cylinder having a section in a track form (see FIG. 1B).

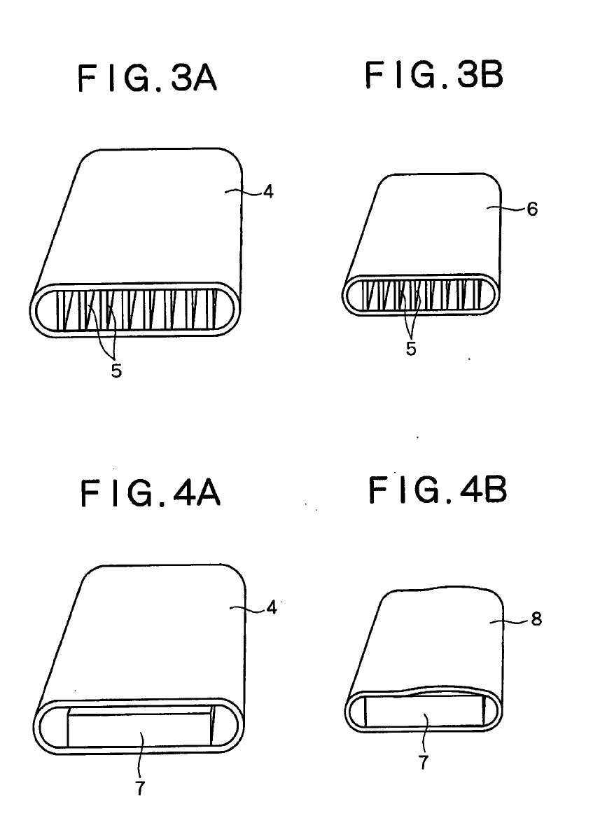

As illustrated in FIG. 3, eight phenol resin plates of 3 mm thickness, 60 mm width and 500 mm length were inserted into the above-mentioned phenol resin deformed cylinder at given intervals. Thereafter, the phenol resin deformed cylinder was heated in an inert atmosphere at 1000° C. to be carbonized, thereby yielding a glass-like carbon deformed pipe. About the resultant glass-like carbon deformed pipe, the intervals between its parallel portions were within the range of ±0.6 mm from the average value thereof, which was 48 mm. Thus, this was suitable as a chamber of a semiconductor producing apparatus. FIG. 3A illustrates the cylinder before the carbonization treatment and the FIG. 3B illustrates the cylinder after the carbonization treatment. In FIGS. 3A and 3B, reference number 4 represents the phenol resin deformed cylinder; 5, the phenol resin plate; and 6, the glass-like carbon deformed pipe.

For comparison, a graphite core 7 made of a rectangular parallelepiped of 48 mm thickness, 320 mm width and 400 mm length was inserted into the same phenol resin deformed cylinder 4 as described above, as illustrated in FIG. 4. In the same way as in the above-mentioned example, the cylinder 4 was heated and carbonized in an inert atmosphere at 1000° C. to yield a glass-like carbon deformed pipe 8. About the resultant deformed pipe 8, the intervals between its parallel portions gave a large fluctuation of ±1.6 mm from the average value thereof, which was 48 mm. This pipe was unsuitable for being used as a chamber of a semiconductor producing apparatus.

### Production of a Bent Pipe

### Example 4

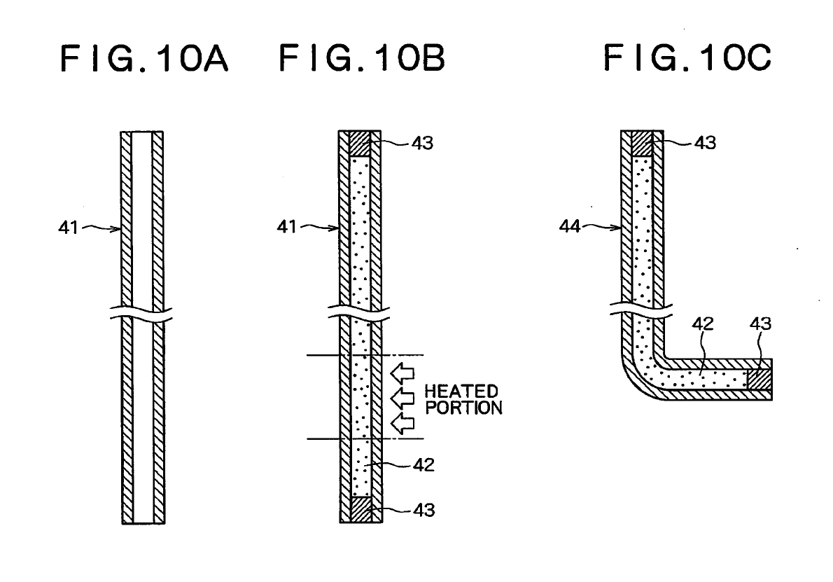

A commercially available liquid phenol resin (Resitop PL-4804, manufactured by Gunei Chemical Industry Co., Ltd.) was subjected to heat treatment at 100° C. under a reduced pressure for 1 hour to adjust the water content therein. The resultant was used as the starting resin of glass-like carbon. Into a cylindrical centrifugal molding die having an inside diameter of 12 mm and a length of 1000 mm was charged 90 g of the above-mentioned glass-like carbon starting resin. While this die was rotated at a rotational speed of 500 rpm, the resin was subjected to centrifugal molding at a die surface temperature of 85° C. for 5 hours, so as to yield a thermosetting resin straight pipe 41 of 12 mm outside diameter, 950 mm length and 2.5 mm thickness (see FIG. 10A). The glass transition point Tg of this pipe 41 was 52° C.

Sea sand 42 (grain size: 300 to 600 μm), manufactured by Wako Pure Chemical Industries, Ltd., was filled into the thermosetting resin pipe 41, and then ends of the pipe were blocked with cottons 43 (see FIG. 10B). Next, while a region of the pipe 41 having distances of 8 to 12 cm from one of the ends of the pipe 41 was heated at 80° C., the region was pushed and bent so as to have an inside curvature radius of 15 mm, thereby deforming the region plastically into an L-shaped bent pipe form. While this form was kept, the pipe was immersed in ice water, so as to be cooled. In this way, the bent structure was fixed to yield a thermosetting resin bent pipe 44 having a bent portion (see FIG. 10C). After the rapid cooling with the ice water, the filled sea sand 42 was taken off.

Next, this thermosetting resin bent pipe 44 was heated to 250° C. at a temperature-rising rate of 2° C./minute in an air atmosphere. The pipe was kept at this temperature for 50 hours to be completely cured. Thereafter, this thermosetting resin bent pipe 44 was subjected to heat treatment in a nitrogen atmosphere at 1000° C. for 5 hours, so as to be carbonized, thereby yielding a glass-like carbon bent pipe having a bent portion. The outside diameter of this pipe was 10 mm, and the thickness was 2 mm.

### Comparative Example 1

A thermosetting resin pipe yielded by the same method as in Example 4 was plastically deformed and bent under the same conditions as in Example 4 except that the sea sand was not filled. As a result, the bent hollow portion was deformed into an inside diameter of 1 mm or less. Thus, the pipe did not function as any member for pipe arrangement.

### Comparative Example 2

A thermosetting resin pipe yielded by the same method as in Example 4 was plastically deformed and bent under the same conditions as in Example 4 except that the heating temperature was set to 55° C., which was below the lower limit temperature (Tg+5° C.) defined in the present invention. As a result, the pipe was cracked and then broken before force for giving a desired deformation ratio was applied to the pipe.

### Comparative Example 3

A thermosetting resin pipe yielded by the same method as in Example 4 was used, and bending of the pipe was started under the same conditions as in Example 4 except that the heating temperature was set to 160° C., which was over the upper limit temperature (150° C.) defined in the present invention. As a result, the thermosetting resin pipe softened once. However, rapid curing reaction took place. Thus, further plastic deformation became impossible before a desired deformation ratio was obtained.

1-3. (canceled)

4. A joint structure for jointing a connecting member to an opening end of a glass-like carbon hollow deformed pipe, which comprises the connecting member, the member being a member wherein a flange portion is formed to be integrated with an outer periphery of a sleeve portion which can be inserted into the glass-like carbon hollow deformed pipe, a sealing material arranged on an outer periphery of the opening end of the glass-like carbon deformed pipe, and a holding member for sandwiching this sealing material between the holding member itself and the flange portion of the connecting member to hold the sealing material, wherein the holding member is fastened and fitted onto the flange portion through a fastening means so as to compress the sealing material held between the holding member and the flange portion, thereby jointing the connecting member to the opening end of the glass-like carbon deformed pipe.

5. The joint structure according to claim 4, wherein an elastic member is arranged on at least one portion of the outer peripheral surface of the sleeve portion inserted into the glass-like carbon deformed pipe.

6. The joint structure according to claim 4, wherein the shape of the section of the glass-like carbon deformed pipe perpendicular to the direction of the hollow is a flat circle, an ellipse, or a shape wherein parallel straight portions are jointed to each other through curved portions.

7. The joint structure according to claim 4, wherein the connecting member and the holding member are each made of a metal or a ceramic.

8. A joint structure for jointing a connecting member to an opening end of a glass-like carbon hollow molded article, which comprises the connecting member, the member being a member wherein a flange portion is formed to be integrated with an outer periphery of a sleeve portion which can be inserted into the glass-like carbon hollow molded article, a sealing material arranged on an outer periphery of the opening end of the glass-like carbon hollow molded article, and a holding member for sandwiching this sealing material between the holding member itself and the flange portion of the connecting member to hold the sealing material, wherein the holding member is fastened and fitted onto the flange portion through a fastening means so as to compress the sealing material held between the holding member and the flange portion, thereby jointing the connecting member to the opening end of the glass-like carbon hollow molded article.
